(19) United States
(12) Patent Application Publication
(10) Pub. No.: US 2007/0193400 A1
(43) Pub. Date: Aug. 23, 2007

(54) Clutch pedal mechanism with variable resistive force

(76) Inventors: Scott A. Kline, Richmond, MI (US); Glenn W. Hoefflin, Fenton, MI (US)

Correspondence Address: GENERAL MOTORS CORPORATION;LEGAL STAFF, MAIL CODE 482-C23-B21, P O BOX 300, DETROIT, MI, 48265-3000, US

(21) Appl. No.: 11/341,179

(22) Filed: Jan. 27, 2006

(51) Int. Cl. G05G 1/14

(52) U.S. Cl. 74/560

(57) ABSTRACT

Provided is a clutch pedal mechanism having a clutch lever member pivotably connected to a pedal mount and having a first position corresponding to an engaged clutch condition, a second position corresponding to an disengaged clutch condition, and a third position intermediate of said first and second position. A plurality of springs are provided to reduce the pedal effort required by the operator to move the clutch lever member from the third position to the second position. At least one of the plurality of springs is selectively removable to selectively increase the pedal force required to move the clutch lever member from the third position to the second position, such that the pedal force may be varied to correspond to the driving style of the operator.

### TECHNICAL FIELD

The present invention relates to clutch pedal mechanisms for vehicles.

### BACKGROUND OF THE INVENTION

A vehicle with a manually shiftable transmission typically has a clutch pedal mechanism that operates a clutch to selectively decouple the engine from the transmission during shift events. The clutch pedal mechanism includes a clutch lever member pivoted on a mount or on a similar stationary support member. The clutch lever member has two end positions, one of which corresponds to the engaged state of the clutch, while the other corresponds to the disengaged state of the clutch. A past-dead-center or over-center spring may be provided that acts on the clutch lever member. The overcenter spring exerts a force on the clutch lever member when the clutch lever member is positioned between an intermediate or dead-center position and the end position corresponding to a disengaged clutch state, such that the force is directed towards this end position. This overcenter spring is effective in reducing the clutch pedal force required by the operator to disengage the clutch.

Systems for reducing the pedal force during the clutch disengagement process are known. The basic premise is to reduce to a reasonable level the amount of pedal force that must be applied to the clutch lever member during clutch disengagement, since the necessary force is quite large due to the necessarily high contact pressure of clutches for modern high-powered engines. The overcenter spring is effective in reducing operator fatigue in stop-and-go traffic conditions. The overcenter spring is typically tuned for a very low pedal effort, this may be undesirable for a performance style of driving, such as closed course driving

### SUMMARY OF THE INVENTION

Accordingly, provided is a clutch pedal mechanism having a clutch lever member pivotably connected at one end to a mounting member. The clutch lever member has a first position corresponding to an engaged clutch condition, a second position corresponding to an disengaged clutch condition, and a third position intermediate of the first and second position. A plurality of springs are pivotably connected to the clutch lever member and are operable to reduce the force required to displace the clutch lever member from the third position to the second position. At least one of the plurality of springs is selectively detachable from the clutch lever member such that the force required to displace the clutch lever member from the third position to the second position may be selectively increased over the force required when all of the plurality of springs are attached.

The above features and advantages and other features and advantages of the present invention are readily apparent from the following detailed description of the best modes for carrying out the invention when taken in connection with the accompanying drawings.

### BRIEF DESCRIPTION OF THE DRAWINGS

FIG. 1 is a side elevational view of a clutch pedal mechanism in three different positions and illustrating the multiple overcenter spring configuration of the present invention; and

FIG. 2 is a spring force vs. pedal displacement diagram illustrating the force exerted on the clutch pedal mechanism in FIG. 1 by the overcenter springs during the clutch pedal mechanism operation.

### DESCRIPTION OF THE PREFERRED EMBODIMENT

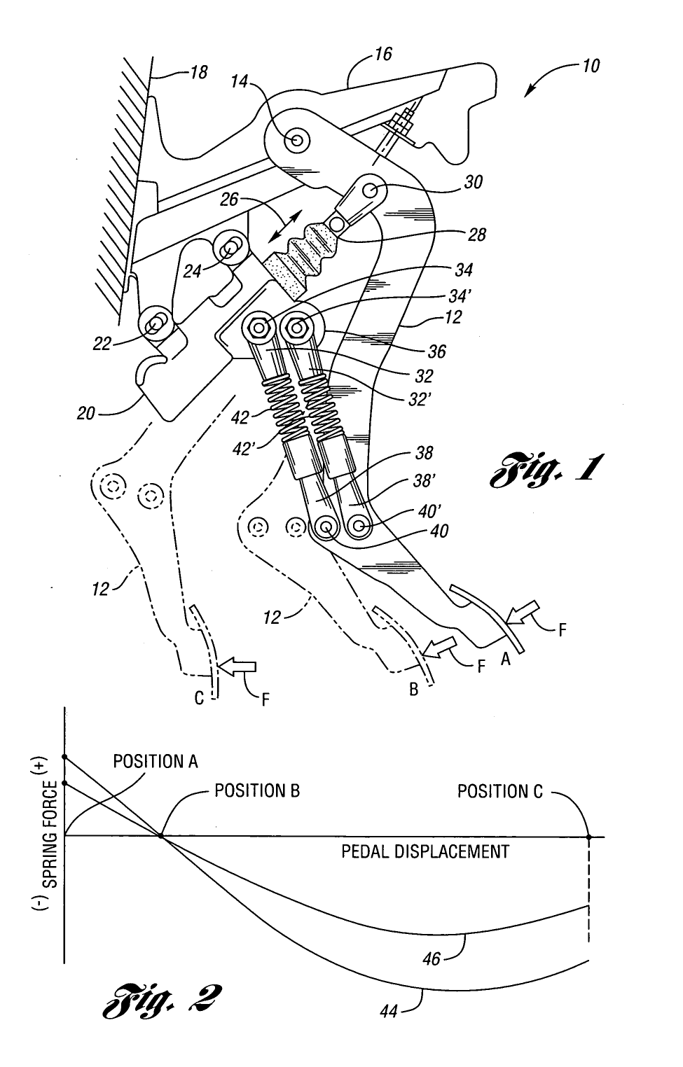

In FIG. 1, a clutch pedal mechanism 10 includes a clutch lever member 12, which is pivoted at pivot point 14 on a mounting member 16, which is attached to the front of dash 18 of a motor vehicle or other suitable attachment point. FIG. 1 illustrates the clutch lever member 12 in three different positions, shown as A, B, and C. The position of the clutch lever member 12, indicated at A, corresponds to the engaged state of a clutch (not shown), and the position of the clutch lever member 12, indicated at C, corresponds to the disengaged clutch state. The intermediate position of the clutch lever member 12, indicated at B, represents the so-called dead-center or overcenter position.

The pedal force, indicated at F, applied to the clutch lever member 12 is transmitted hydraulically to the clutch. For this purpose, a hydraulic cylinder 20 is secured to the pedal mount 12 at attachment points 22 and 24. A hydraulic piston, not shown, is reciprocally movable within the hydraulic cylinder 20 in the direction of arrow 26. The piston is connected with a piston rod 28 that is pivotably connected to the clutch lever member 12 at a pivot point 30.

A first pair of spring guides 32 and 32′ are pivoted at attachment points 34 and 34′, respectively, on an angular projection 36 of the hydraulic cylinder 20. A second pair of spring guides 38 and 38′ articulate with the clutch lever member 12 approximately in the lower third of the clutch lever member 12 at attachment points 40 and 40′, respectively. The spring guides 32, 38 and 32′, 38′ are designed and mounted in such a way that they can move relative to each other in the direction of their (congruent) longitudinal axes. The spring guides 32 and 40 hold a spring 42, while the spring guides 32′ and 40′ hold a spring 42′. In the clutch pedal mechanism 10, the springs 42 and 42′ act as overcenter springs, which reduce the pedal force required to depress the clutch lever member 12, thereby disengaging the clutch. The springs 42 and 42′ are preferably helical coil compression springs; however, those skilled in the art will recognize that other springs may be used such as elastomeric members. Additionally, torsional springs may be used while remaining within the scope of that which is claimed. The overcenter points of springs 42 and 42′ need not coincide.

The springs 42 and 42′ are most strongly stressed at the dead-center position B. Nevertheless, the reducing force at position B is approximately equal to zero, since the spring attachment points at 34, 34′ and 40, 40′ and the center of rotation at pivot point 14 of the clutch lever member 12 all lie on a generally straight line. Therefore, there is little or no resultant lever arm and thus little or no resultant moment from the force of the compression springs 42 and 42′. The clutch lever member 12 at position C creates a resultant lever arm for the force of the compression springs 42 and 42′, so that a moment is applied to the clutch lever member 12 in the direction of clutch disengagement. However, when the clutch lever member 12 moves toward position A, a lever arm develops in such a way that the moment resulting from the force of the compression springs 42 and 42′ and the lever arm 12 amplifies the pedal operating force, thereby allowing the clutch lever member 12 to seat securely in the undepressed state at position A. In both cases, the compression springs 42 and 42′ relax from the dead center position B of the clutch lever member 12, shown in FIG. 1.

Referring now to FIG. 2, there is shown a spring force vs. pedal displacement diagram illustrating characteristic spring force curves 44 and 46 of the clutch pedal mechanism 10. A positive value for spring force results in an increase in pedal force F, shown in FIG. 1, required to operate the clutch pedal mechanism 10. Alternately, a negative spring force corresponds to a decrease in the pedal force F required to operate the clutch pedal mechanism 10. The curves 44 and 46 can be adjusted by suitable choice of the spring constant, the spring pre-stress and the geometry of the spring pivot. In the first segment of the path of the clutch lever member 12, i.e., from position A to the dead-center position B, there is an increase in the pedal force F required to operate the clutch pedal mechanism 10. However, movement from the dead-center position B to the position C, the pedal force F is supported by the springs 42 and 42′ as a result of the torque reversal, this spring support develops in the region in which the pedal force F requirement is otherwise higher than it would be in the absence of such support by springs 42 and 42′.

The curve 44 illustrates the force exerted on the clutch lever member 12 by both springs 42 and 42′. The present invention provides that one of the springs 42 and 42′ can be selectively detached, such as by unbolting, or otherwise rendered nonfunctional within the clutch pedal mechanism 10. The curve 46 illustrates the force exerted on the clutch lever member 12 by one of the springs 42 and 42′. By removing one of the springs 42 and 42′, the pedal force F required to depress the clutch lever member 12 is increased as the clutch lever member 12 moves from position B to position C. This is desirable when operating the vehicle in a performance-oriented fashion, such as closed course driving. The clutch pedal mechanism 10 may be returned to the two spring configuration when the operator wishes to have a lower pedal force F, such as when driving in stop-and-go traffic.

While the best modes for carrying out the invention have been described in detail, those familiar with the art to which this invention relates will recognize various alternative designs and embodiments for practicing the invention within the scope of the appended claims.

1. A clutch pedal mechanism comprising:
a clutch lever member pivotably connected at one end to a mounting member;
a plurality of springs pivotably connected to said clutch lever member and operable to reduce the force required to displace said clutch lever member over substantially the entirety of the travel of said clutch lever member; and
wherein at least one of said plurality of springs is selectively detachable from said clutch lever member such that the force required to displace said clutch lever member over substantially the entirety of the travel of said clutch lever member may be selectively increased over the force required when said at least one of said plurality of springs is attached.

2. The clutch pedal mechanism of claim 1, wherein said plurality of springs are pivotably attached at a lower portion of said clutch lever member opposite said mounting member.

3. The clutch pedal mechanism of claim 1, wherein said at least one of said plurality of springs is a helical coil compression spring.

4. The clutch pedal mechanism of claim 1, further comprising:
a hydraulic cylinder operable to control clutch engagement; and
wherein said hydraulic cylinder is selectively operated through movement of said clutch lever member.

5. A clutch pedal mechanism comprising:
a clutch lever member pivotably connected at one end to a mounting member, said clutch lever member having a first position corresponding to an engaged clutch condition, a second position corresponding to an disengaged clutch condition, and a third position intermediate of said first and second position;
a plurality of springs pivotably connected to said clutch lever member and operable to reduce the force required to displace said clutch lever member from said third position to said second position; and
wherein at least one of said plurality of springs is selectively 10 detachable from said clutch lever member such that the force required to displace said clutch lever member from said third position to said second position may be selectively increased over the force required when said at least one of said plurality of springs is attached.

6. The clutch pedal mechanism of claim 5, wherein said plurality of springs are pivotably attached at a lower portion of said clutch lever member opposite said mounting member.

7. The clutch pedal mechanism of claim 5, wherein said at least one of said plurality of springs is a helical coil compression spring.

8. The clutch pedal mechanism of claim 5, further comprising:
a hydraulic cylinder operable to control clutch engagement; and
wherein said hydraulic cylinder is selectively operated through movement of said clutch lever member.

9. A clutch pedal mechanism comprising:
a clutch lever member pivotably connected at one end to a mounting member, said clutch lever member having a first position corresponding to an engaged clutch condition, a second position corresponding to an disengaged clutch condition, and a third position intermediate of said first and second position;
a plurality of helical coil springs pivotably connected to said clutch lever member and operable to reduce the force required to displace said clutch lever member from said third position to said second position;
wherein said plurality of helical coil springs are pivotably attached at one portion of said clutch lever member opposite said mounting member; and
wherein at least one of said plurality of helical coil springs is selectively detachable from said clutch lever member such that the force required to displace said clutch lever member from said third position to said second position may be selectively increased over the force required when said at least one of said plurality of helical coil springs is attached.

10. The clutch pedal mechanism of claim 9, further comprising:
a hydraulic cylinder operable to control clutch engagement; and
wherein said hydraulic cylinder is selectively operated through movement of said clutch lever member.
